(19) United States
(12) Patent Application Publication
(10) Pub. No.: US 2024/0156152 A1
(43) Pub. Date: May 16, 2024

(54) Aerosol-Generating Article and Method for Producing an Aerosol-Generating Article

(71) Applicant: JT International SA, Geneva (CH)

(72) Inventor: Akira Yamaguchi, Geneva (CH)

(73) Assignee: JT International SA, Geneva (CH)

(21) Appl. No.: 18/284,222

(22) PCT Filed: Apr. 19, 2022
(86) PCT No.: PCT/EP2022/060293

§ 371 Date: Sep. 26, 2023

(30) Foreign Application Priority Data
Apr. 20, 2021 (EP) 21169329.6

(51) Int. Cl. A24D 1/02; A24B 15/10; A24C 5/00; A24C 5/01; A24D 1/00; A24D 1/20; A24F 40/20; A24F 40/465; H05B 3/46

(52) U.S. Cl. CPC A24D 1/02; A24B 15/10; A24C 5/005; A24C 5/01; A24D 1/002; A24D 1/20; A24F 40/20; A24F 40/465; H05B 3/46

(57) ABSTRACT

An aerosol-generating article includes a rod of aerosol-generating substrate, a mouthpiece including a plug of filtration material, a wrapper, and a tobacco-containing layer including tobacco and an aerosol-forming agent, wherein the rod is wrapped by the wrapper and by the tobacco-containing layer, and the tobacco-containing layer is positioned in contact with a surface of the wrapper. A method for producing an aerosol-generating article includes preparing a tobacco-containing slurry, depositing the slurry onto a first sheet to form a sheet coated with a tobacco-containing layer, attaching a paper sheet to the first sheet to form a wrapper before or after depositing the slurry onto the first sheet so that the paper sheet and the tobacco-containing layer are on opposing sides of the first sheet, and subsequently wrapping a rod of aerosol-generating substrate with the wrapper including the first sheet, so that the tobacco-containing layer is facing the rod.

### TECHNICAL FIELD OF THE INVENTION

The present invention relates to an aerosol-generating article for producing an inhalable upon heating in an aerosol-generating device and method for producing an aerosol-generating article.

### PRIOR ART

The popularity and use of reduced-risk devices (also known as vaporisers) has grown rapidly in the past few years. Reduced-risk devices are used as substitute for traditional tobacco products such as cigarettes. Various devices and systems are available that heat or warm aerosol-generating substances as opposed to burning tobacco in conventional tobacco products. Commonly available reduced-risk devices are heated aerosol-generating devices, also known as heat-not-burn devices (HNB). Devices of this type generate an aerosol or vapor by heating an aerosol-generating substrate that typically comprises moist leaf tobacco or other suitable aerosolisable material to a temperature typically in the range 150° C. to 350° C. Heating an aerosol-generating substrate, but not combusting or burning it, releases an aerosol that comprises the components and flavor desired by the user, without generating toxic or carcinogenic byproducts of combustion and burning. Furthermore, the aerosol produced by heating the tobacco or other aerosolisable material does not typically comprise the burnt or bitter taste resulting from combustion and burning. Therefore, the aerosol-generating substrate does not require sugars and other additives that are typically added to make the smoke and/or vapor more palatable for the user.

A typical aerosol-generating device comprises a heating chamber, i.e. an oven. The heating chamber is configured to receive a solid aerosol-generating article (i.e. an article comprising an aerosol-generating substrate) such as a tobacco stick.

One problem of HNB products is that they do not deliver enough tobacco taste at initial puff, in particular when the aerosol-generating device is an outer heating device (i.e., where the heater is external to the aerosol-generating article to heat the substrate from its outer surface).

It is an object of the present invention to address the above issues and to provide an aerosol-generating article with improved delivery of tobacco taste. In particular, it is an object of the present invention to improve the delivery of tobacco taste of an aerosol-generating article at initial puff in an HNB device.

### SUMMARY OF THE INVENTION

The present invention solves this problem by providing an aerosol-generating article for producing an inhalable upon heating in an aerosol-generating device and a method for producing the aerosol-generating article.

The aerosol-generating article comprises a rod of aerosol-generating substrate (tobacco rod), which is wrapped by a wrapper and by a tobacco-containing layer. The tobacco-containing layer comprises tobacco and an aerosol-forming agent and is in contact with a surface of the wrapper. The wrapper is in contact with the heating chamber, thereby allowing a faster heating of the tobacco-containing layer. Upon heating in the aerosol-generating device, the tobacco-containing layer generates sufficient vapor and/or aerosol at initial puff even before the rod of the aerosol-generating substrate is sufficiently heated to deliver tobacco taste. Thus, sufficient tobacco taste can be delivered even at initial puff.

In a first aspect, the present invention as defined in claim 1 is directed to an aerosol-generating article for producing an inhalable upon heating in an aerosol-generating device, the aerosol-generating article comprising:
a rod of aerosol-generating substrate comprising tobacco,
a mouthpiece comprising a plug of filtration material,
a wrapper, and
a tobacco-containing layer comprising tobacco and an aerosol-forming agent,
wherein the rod of aerosol-generating substrate is wrapped by the wrapper and by the tobacco-containing layer, and the tobacco-containing layer is positioned in contact with a surface of the wrapper.

In a second aspect, the present invention as defined in claim 18 is directed to a method for producing an aerosol-generating article, the method comprising the steps of:
(i) preparing a tobacco-containing slurry,
(ii) depositing the tobacco-containing slurry onto a first sheet to form a sheet coated with a tobacco-containing layer,
(iii) attaching a paper sheet to the first sheet to form a wrapper before or after depositing the tobacco-containing slurry onto the first sheet so that the paper sheet and the tobacco-containing layer are on opposing sides of the first sheet, and
(iv) subsequently wrapping a rod of aerosol-generating substrate with the wrapper comprising the first sheet coated with the tobacco-containing slurry, so that the tobacco-containing layer is facing the rod of aerosol-generating substrate.

Preferred embodiments of the aerosol-generating article and the method for producing an aerosol-generating article are subject to the dependent claims.

### BRIEF DESCRIPTION OF THE FIGURES

FIG. 1 shows a typical aerosol-generating device (2) comprising a heating chamber (21), i.e. an oven. The heating chamber (21) is configured to receive a solid aerosol-generating article (1) (i.e. an article comprising an aerosol-generating substrate) such as tobacco sticks.

FIG. 2 shows an aerosol-generating article (1) according to the present invention comprising a rod of aerosol-generating substrate (10) comprising tobacco and wrapped by a wrapper and a tobacco containing layer, a mouthpiece (20) comprising a plug of filtration material, and a tubular member (50).

FIG. 3 shows a cross-sectional cut through the aerosol-generating article (1) for producing an inhalable upon heating in an aerosol-generating device (2) according to the present invention. The aerosol-generating article (1) comprises a rod of aerosol-generating substrate (10) comprising tobacco, a mouthpiece (20) comprising a plug of filtration material, a wrapper (30), and a tobacco-containing layer (40) comprising tobacco and an aerosol-forming agent. The aerosol-generating article (1) may comprise a tubular member (50). The wrapper (30) may comprise an outer paper layer (32) and an inner layer (31).

FIG. 4 shows the wrapping of a rod of aerosol-generating substrate (10) by a tobacco-containing layer (40), an inner layer (31) and an outer paper layer (32) in this order.

FIGS. 5 and 6 are flowcharts showing alternative sequences of the steps of the method of the present invention for producing an aerosol-generating article.

FIG. 5 shows the steps of (i) preparing a tobacco-containing slurry, (ii) depositing the tobacco-containing slurry onto a first sheet to form a sheet coated with a tobacco-containing layer, (iii) attaching a paper sheet to the first sheet to form a wrapper after depositing the tobacco-containing slurry onto the first sheet, and (iv) wrapping a rod of aerosol-generating substrate with the wrapper.

FIG. 6 shows the steps of (i) preparing a tobacco-containing slurry, (ii) attaching a paper sheet to the first sheet to form a wrapper before depositing the tobacco-containing slurry onto the first sheet, (iii) depositing the tobacco-containing slurry onto the first sheet attached to paper sheet to form a sheet coated with a tobacco-containing layer, and (iv) wrapping a rod of aerosol-generating substrate with the wrapper.

### DETAILED DESCRIPTION OF THE INVENTION

Aerosol-Generating Article

The aerosol-generating article (1) for producing an inhalable upon heating in an aerosol-generating device (2) according to the first aspect of the present invention comprises
a rod of aerosol-generating substrate (10) comprising tobacco,
a mouthpiece (20) comprising a plug of filtration material,
a wrapper (30), and
   a tobacco-containing layer (40) comprising tobacco and an aerosol-forming agent.

The rod of aerosol-generating substrate (10) is wrapped by the wrapper (30) and by the tobacco-containing layer (40), and the tobacco-containing layer (40) is positioned in contact with a surface of the wrapper (30).

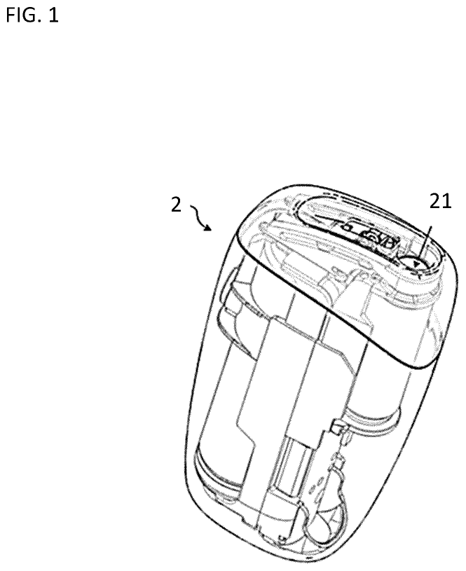

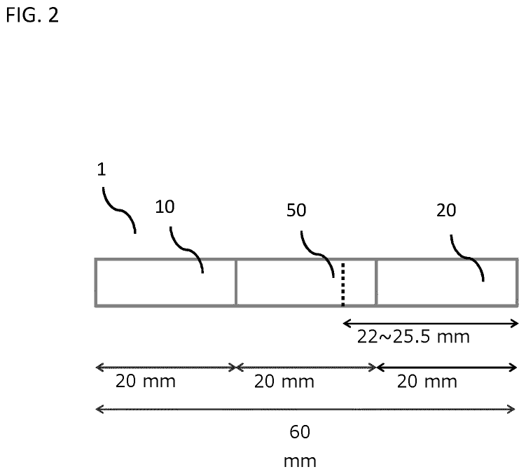

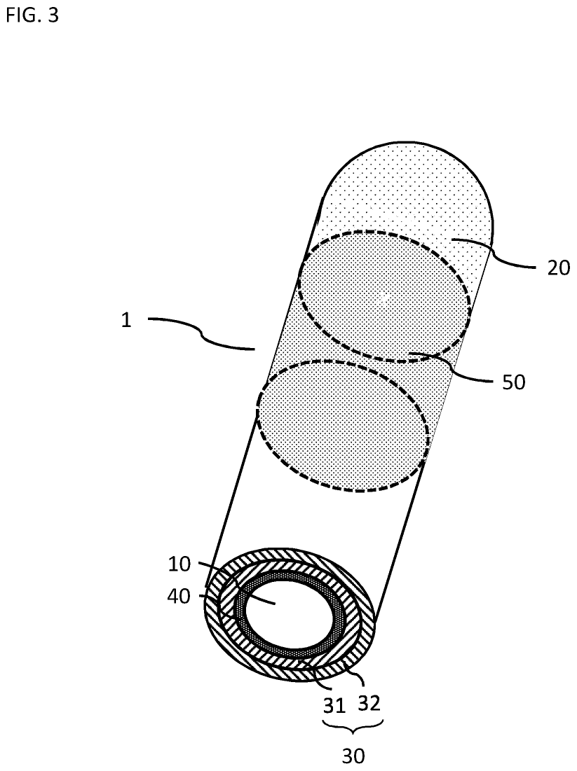

The aerosol-generating article generates vapor and/or aerosol upon heating in an aerosol-generating device (2). A typical aerosol-generating device (2) as shown in FIG. 1 comprises a heating chamber (21), i.e. an oven. The heating chamber (21) is configured to receive the aerosol-generating article (1). The aerosol-generating article can be inserted into the heating chamber. The heating chamber may be a metal cup with a heater applied thereon. The heater may for instance be a thin film heater. An aerosol-generating article (1) as shown in FIGS. 2 and 3 is inserted into the heating chamber (21) of the aerosol-generating device (2) so that the rod of aerosol-generating substrate (10) is surrounded by the heating chamber (21) and the mouthpiece (20) is outside the heating chamber (21).

In a variant for heat by induction, the aerosol generating device may comprise a receiving chamber which comprises an electromagnetic field generator which may comprise an inductive coil (e.g. a Litz wire or cable) configured to generate an alternative electromagnetic field for inductively heating at least one inductively heatable susceptor inserted inside the aerosol-generating article.

Rod of Aerosol-Generating Substrate

The length of the rod of aerosol-generating substrate (10) comprising tobacco (tobacco rod) can vary. The rod has preferably a length of at least 10 mm and not more than 50 mm. More preferably, the rod has a length of at least 15 mm and not more than 40 mm. Most preferably, the rod has a length of at least 20 mm and not more than 30 mm. The circumference of the tobacco rod can vary. The rod of aerosol-generating substrate has preferably a circumference in the range of 16 mm to about 50 mm and more preferably 20 to 50 mm, even more preferably 20 to 25 mm, most preferably about 22 mm.

The aerosol-generating substrate comprises tobacco, preferably reconstituted tobacco. The tobacco generates an aerosol upon heating the aerosol generating article in an aerosol generating device. The aerosol-generating substrate may comprise tobacco in the form of randomly oriented tobacco strands, randomly oriented tobacco shreds, gathered tobacco sheet(s), tobacco mousse or combinations thereof. The aerosol-generating substrate may also comprise further easily aerosolisable material, preferably plant material and/or cellulose-based material. More particularly, the aerosol-generating substrate may also comprise tobacco leaf, tobacco lamina, tobacco stem, tobacco scrap, reconstituted tobacco, cellulose pulp or combinations thereof.

Reconstituted tobacco may be obtained by a “cast sheet process”, for which tobacco is ground up into a fine powder and mixed with water, binders, additives, humectants and optional wood pulp fibres. The slurry of these elements is ‘cast’ or poured out onto a surface to form a thin film and is then heated and dehydrated to produce a reconstituted tobacco sheet. Commonly, cast sheet reconstituted tobacco is used to make cut filler. In alternative, reconstituted tobacco can be obtained by a “paper making process” according to the following procedure. Tobacco stems or leaf is refined (i.e. the fibres are separated) and extracted with water. The water-insoluble pulp is separated and further refined to a desired consistency and formed into a mat, which is then dried to provide a reconstituted tobacco sheet. The reconstituted tobacco may also be obtained by “extrusion”. The tobacco and other ingredients are processed under controlled conditions of temperature, moisture and pressure to provide a reconstituted tobacco of a desired shape e.g. strands, sheets, rods or tubes.

These materials can improve the generation of aerosol upon heating the aerosol generating article in an aerosol generating device.

The aerosol-generating substrate may comprise one or more compound(s) selected from the group consisting of a binder, an aerosol-forming agent, a humectant, and a non-tobacco-flavorant.

The aerosol-forming agent improves the generation of vapor and/or an aerosol upon heating the aerosol-generating article in an aerosol-generating device. A preferred aerosol-forming agent may act as humectant. The aerosol-forming agent may comprise one or more compound(s) selected from the group consisting of polyhydric alcohols, diols, esters of polyhydric alcohols and aliphatic esters of mono-, di- or polycarboxylic acids. A humectant is typically a molecule with several hydrophilic groups such as hydroxyl groups, carboxyl groups or esters thereof. Therefore, the above-mentioned preferred aerosol-forming agents, which exhibit such hydrophilic groups, also act as humectant. The humectant is preferably glycerin and/or polypropylene glycol.

The aerosol-forming agent preferably comprises one or more compound(s) selected from the group consisting of polypropylene glycol (PG), triethylene glycol, 1-3-butanediol, glycerin, glycerol monoacetate, glycerol diacetate, glycerol triacetate, triethyl citrate, ethyl myristate, isopropyl myristate, methyl stearate, dimethyl dodecanedioate and dimethyl tetradecanedioate. The aerosol-forming agent is most preferably glycerin and/or polypropylene glycol.

The non-tobacco flavorant may be one or more selected from the group consisting of cocoa, fruit extracts, liquorice, vanillin, ethyl vanillin, coffee, tea, maple, menthol, mint, peppermint, spearmint, wintergreen, nutmeg, clove, lavender, cardamom, ginger, honey, anise, sage, cinnamon, sandalwood, jasmine, cascarilla. The non-tobacco flavorant may also comprise syrups, such as high fructose corn syrup.

The binder may comprise gum, carbohydrate, or a combination thereof. The gum may be one or more compound(s) selected form the group consisting of gellan gum, xanthan gum, arabic gum, locust bean gum and agar agar. The carbohydrate may be a monosaccharide, a disaccharide, a polysaccharide, a cellulose derivative or a combination thereof. The binder may also comprise a sugar syrup. The binder is preferably one or more compound(s) selected form the group consisting of gellan gum, starch, and carboxymethyl cellulose.

In a particularly preferred embodiment, the aerosol-generating substrate comprises randomly oriented tobacco strands, tobacco leaf and at least one of glycerin and polypropylene glycol. In another particularly preferred embodiment, the aerosol-generating substrate comprises randomly oriented tobacco shreds, tobacco lamina and at least one of glycerin and polypropylene glycol. In a further particularly preferred embodiment, the aerosol-generating substrate comprises gathered tobacco sheets, tobacco leaf and at least one of glycerin and polypropylene glycol.

Mouthpiece

The mouthpiece (20) is used by the smoker to inhale the aerosol generated by the aerosol-generating article upon heating in the aerosol-generating device. The mouthpiece is preferably rod-shaped. The mouthpiece may comprise an opening or pores facing the rod of aerosol-generating substrate and being adapted for ingress of the aerosol generated by the aerosol-generating article into the mouthpiece. The opposing end of the mouthpiece may comprise an opening or pores adapted for inhalation of the aerosol by the smoker. The mouthpiece comprises one or more plugs of a filtration material.

The plug of the filtration material is preferably cylindrical or tubular. The filtration material may preferably comprise one or more components selected from the group consisting of cellulose acetate, paper, humectants, activated charcoal particles and additives. The humectant may be one or more selected from the group consisting of diols and polyhydric alcohols. The humectant is more preferably one or more selected from the group consisting of ethylene glycol, propylene glycol and glycerol. The additives are preferably one or more selected from the group consisting of acetaldehyde, acetic acid, triacetin, and phenol.

Tubular Member

A tubular member (50) may be present between the rod of aerosol-generating substrate (10) and the mouthpiece (20), as can be seen from FIGS. 2 and 3. The tubular member (50) is preferably hollow and is more preferably a paper or a polylactic acid (PLA) tube. Most preferably, a tipping paper may wrap over the mouthpiece, the tubular member and the tobacco rod and may at least partially overlap with the wrapper (30). The tubular member may also be partially hollow. A portion or all its longitudinal length may be filled with a filler such as a PLA gathered film.

The tubular member may be sized to provide a sufficient length for aerosol to cool down. Preferably, the tubular member has a length comprised between 15 and 28 mm, preferably 18 to 25 mm, most preferably about 20 mm. The tubular member may comprise chicanes, channels, flow barriers which allow to increase the aerosol flow path through the tubular member.

A ventilation zone may be provided through the tubular member to allow air to be drawn in the tubular member and to dilute the aerosol. The ventilation zone may be formed by one or more rows of perforations. The perforations may be formed by laser or other technique through the tubular member and the wrapper.

Wrapper

The rod of aerosol-generating substrate (10) is wrapped by a wrapper (30) and by a tobacco-containing layer (40) comprising tobacco and an aerosol-forming agent, wherein the tobacco-containing layer (40) is positioned in contact with a surface of the wrapper (30). The tobacco-containing layer (40) is preferably coated on the inner surface of the wrapper (30). The inner surface of the wrapper (30) is the surface facing the rod of aerosol-generating substrate (10), when the wrapper (30) is wrapped around the rod of aerosol-generating substrate (10).

Typically, the wrapper (30) is wrapped around the aerosol-generating substrate (10) as to form a generally cylindrical rod-shaped rod of aerosol-generating substrate. Preferably, the wrapper (30) is formed such that each end of the tobacco rod is open to expose the tobacco contained therein and to allow a passage of drawn air therethrough.

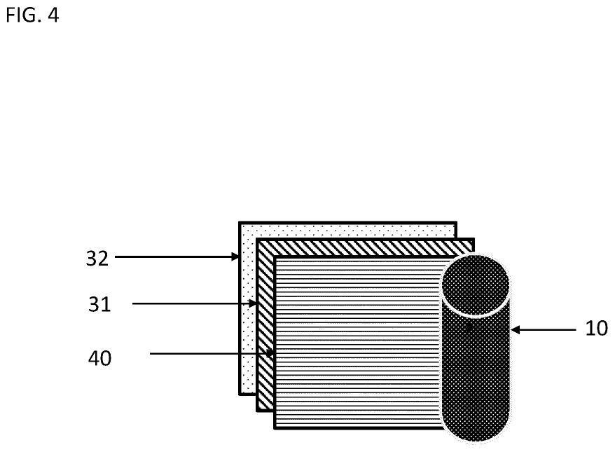

The wrapper (30) may comprise a heat-conductive sheet. In a preferred embodiment as shown in FIGS. 3 and 4, the wrapper preferably comprises an outer paper layer (32) and an inner layer (31) facing the rod of aerosol-generating substrate (10), wherein the inner layer (31) is a heat-conductive sheet. In this embodiment, the inner surface of the wrapper (30) facing the rod of aerosol-generating substrate (10) is the surface of the heat-conductive sheet (31). The tobacco-containing layer (40) is most preferably coated on the surface of the heat-conductive sheet opposed to the outer paper layer (32). The heat-conductive sheet may serve as a carrier for the tobacco-containing layer (40) and improves heat dissipation and even heat supply to the tobacco-containing layer (40).

The aerosol generating article, preferably the wrapper, may contain an inductively heatable susceptor element, e.g., in the form of an inductive metal sheet, inductive layer and/or inductive particles. The inductively heatable susceptor element may be in the form of a thin sheet, which is in the following designated as susceptor foil. With the application of an alternating electromagnetic fields in its vicinity, the susceptor element may generate heat due to eddy currents and magnetic hysteresis losses resulting in a conversion of energy from electromagnetic energy to heat and so may increase the temperature of the tobacco-containing layer.

The outer paper layer (32) may be made of a pulp type paper. More particularly, the pulp type paper may be made of wood, flax, or mixed pulp. The paper layer is preferably chlorine-free.

The heat-conductive sheet is preferably on the inner side of the wrapper (30) facing the rod of the aerosol-generating article. The heat-conductive sheet is preferably made of a metal, more preferably a metal selected from the group of aluminum, copper and tin, and is most preferably made of aluminum. The heat-conductive sheet may have a thickness in the range of 0.005 mm to 0.2 mm, preferably 0.01 mm to 0.05 mm.

Tobacco-Containing Layer

The tobacco-containing layer (40) is positioned in contact with a surface of the wrapper (30). When the aerosol-generating article (1) is placed in the aerosol-generating device (2), the wrapper (30) is in contact with the heating chamber (21) of the aerosol-generating device (2). Upon heating the aerosol-generating article (1) in an aerosol-generating device, the tobacco-containing layer (40), which is in contact with the surface of the wrapper (30), is efficiently heated and thus generates sufficient vapor and/or aerosol at initial puff, even before the rod of the aerosol-generating substrate (10) is sufficiently heated. The vapor and/or aerosol generated by the tobacco-containing layer (40) at initial puff has tobacco flavor. Thus, sufficient tobacco taste can be delivered at initial puff. Therefore, the tobacco taste delivery at initial puff is improved. At the time the tobacco-containing layer (40) does no longer generate significant tobacco flavor, the tobacco rod is sufficiently heated to deliver aerosol and taste.

The tobacco-containing layer (40) may be coated on an inner surface of the wrapper (30). When the wrapper (30) comprises a heat-conductive sheet, the tobacco-containing layer (40) may be in contact with the heat-conductive sheet facing the aerosol-generating substrate (10), so that the tobacco-containing layer (40) is arranged in-between the heat-conductive sheet of the wrapper (30) and the aerosol-generating substrate (10). In a more preferable embodiment, the wrapper (30) comprises an outer paper layer (32) and an inner layer (31) of a heat-conductive sheet and the tobacco-containing layer (40) is coated on the surface of the heat-conductive sheet opposed to the outer paper layer (32). In this embodiment, the tobacco-containing layer (40) faces the rod of aerosol-generating substrate (10).

When the wrapper comprises a susceptor foil as the inductively heatable susceptor element, the foil may be placed in contact with the tobacco-containing substrate. The susceptor foil may also be placed on the opposed surface of the tobacco-containing substrate (40), i.e., between the tobacco-containing substrate and the rod of aerosol-generating substrate (10).

When the tobacco-containing layer (40) is in contact with the heat-conductive sheet, the delivery of tobacco taste at first puff can be further improved because the heat transferred through the oven or heater and to the aerosol-generating article is supplied more evenly and more efficiently to the tobacco-containing layer (40).

In an alternative embodiment, the outer layer of the wrapper is the heat-conductive sheet and the inner layer of the wrapper is a paper layer.

The tobacco-containing (40) layer preferably has a thickness in the range of 0.1 to 0.5 mm, and more preferably in the range of 0.1 to 0.2 mm. If the thickness of the tobacco-containing layer (40) is in this range, the delivery of tobacco taste at first puff can be further improved. If the thickness of the layer is 0.1 mm or more, the time period during which tobacco taste is delivered by the tobacco-containing layer (40) is further extended. When the thickness of the tobacco-containing layer (40) is not more than 0.5 mm, the delivery of tobacco taste by the tobacco-containing layer (40) is further accelerated. Thus, the continuous delivery of tobacco flavor starting from initial puff is further improved when the tobacco-containing layer (40) has a thickness in the range of 0.1 to 0.5 mm.

The tobacco-containing layer (40) contains tobacco and an aerosol-forming agent. The tobacco in the tobacco-containing layer (40) may be tobacco particles and preferably micronized tobacco powder. Micronized tobacco powder may have a particle size of 40 μm or less, preferably 30 μm or less. The small particle size enhances the delivery of tobacco taste at first puff. More particularly, a smaller particle size allows to increase the efficiency of heat dissipation in the tobacco-containing layer (40) due to a reduced inter-particle void volume.

In the present context, the particle size refers to Dv90 which represents the maximum particle size below which 90% of the sample volume exits. The particle size is determined on a dry sample of micronized tobacco powder by dispersion and by laser diffraction analysis using Malvern Mastersizer 3000 instrument with an Aero Dry Dispersion unit with a nominal air line pressure set to 6 bar and a vacuum unit with an air flow of 39 L/s, a vacuum of 20.4 kPa and diameter of vacuum hose of 38 mm connected to the vacuum port of the optical unit.

The tobacco-containing layer (40) may contain further additives such as binder, non-tobacco flavorant and humectant. The total content of tobacco and the optional non-tobacco flavorant in the tobacco-containing layer (40) is preferably 40% or more, more preferably 50% or more and most preferably 60% or more by weight of the tobacco-containing layer (40). The total content of the binder, the humectant and the aerosol-forming agent is preferably not more than 60%, more preferably not more than 50%, and most preferably not more than 40% by weight of the tobacco-containing layer (40). The total content of the binder, the humectant and the aerosol-forming agent is preferably more than 8%, more preferably more than 10%, and most preferably more than 12% by weight of the tobacco-containing layer (40).

The aerosol-forming agent forms vapor and/or an aerosol upon heating the aerosol-generating article in an aerosol-generating device. A preferred aerosol-forming agent may act as humectant. The aerosol-forming agent may comprise one or more compound(s) selected from the group consisting of polyhydric alcohols, diols, esters of polyhydric alcohols and aliphatic esters of mono-, di- or polycarboxylic acids. The aerosol-forming agent may produce a visible aerosol.

The polyhydric alcohol may be glycerol.

The diol may be one or more selected from the group consisting of polypropylene glycol (PG), triethylene glycol, and 1-3-butanediol.

The ester of polyhydric alcohol may be one or more selected from the group consisting of glycerol monoacetate, glycerol diacetate, and glycerol triacetate.

The aliphatic ester of a mono-, di- or polycarboxylic acid may be one or more selected from the group consisting of methyl stearate, ethyl stearate, isopropyl stearate, methyl myristate, ethyl myristate, isopropyl myristate, dimethyl dodecanedioate, diethyl dodecanedioate, diisopropyl dodecanedioate, dimethyl tetradecanedioate, diethyl tetradecanedioate, diisopropyl tetradecanedioate, trimethyl citrate, and triethyl citrate.

The aerosol-forming agent preferably comprises one or more selected from the group consisting of polypropylene glycol (PG), triethylene glycol, 1-3-butanediol, glycerin, glycerol monoacetate, glycerol diacetate, glycerol triacetate, triethyl citrate, ethyl myristate, isopropyl myristate, methyl stearate, dimethyl dodecanedioate and dimethyl tetradecanedioate. The aerosol-forming agent is most preferably glycerin and/or polypropylene glycol (PG). The glycerin may be vegetable glycerin (VG). Vegetable glycerin is glycerin obtained from plant oils such as soybean oil, coconut oil or palm oil.

The aerosol-forming agent preferably acts as humectant. A humectant is a hygroscopic substance used to keep a material moist. A humectant is typically a molecule with several hydrophilic groups such as hydroxyl groups, carboxyl groups or esters thereof. Therefore, the above-mentioned preferred aerosol-forming agents, which exhibit such hydrophilic groups, also act as humectant. The humectant is thus most preferably glycerin and/or polypropylene glycol.

The tobacco-containing layer (40) may comprise a binder. The binder may comprise gum, carbohydrate, or a combination thereof. The gum may be one or more compound(s) selected form the group consisting of gellan gum, xanthan gum, arabic gum, locust bean gum and agar agar. The carbohydrate may be a monosaccharide, a disaccharide, a polysaccharide, a cellulose derivative or a combination thereof. The monosaccharide is preferably one or more selected from the group consisting of glucose, fructose and galactose. The disaccharide is preferably one or more selected from the group consisting lactose, maltose and sucrose. The polysaccharide is preferably starch. The cellulose derivative is preferably one or more selected from the group consisting of hydroxypropyl-methylcellulose (HPMC), hydroxypropyl cellulose (HPC), carboxymethyl cellulose (CMC), hydroxyethyl cellulose, methyl cellulose (MC), and ethyl cellulose. The binder may also be a syrup such enzyme-converted syrup, acid-converted syrup, maltose syrup, high-fructose corn syrup, hydrogenated starch syrup, and honey. The binder is most preferably one or more compound(s) selected form the group consisting of gellan gum, starch, and carboxymethyl cellulose.

The tobacco-containing layer (40) may comprise tobacco particles and preferably micronized tobacco powder. The micronized tobacco powder preferably has a mean particle size of 30 microns or less.

The tobacco-containing layer (40) may further comprise non-tobacco flavorant. The non-tobacco flavorant may be one or more selected from the group consisting of cocoa, fruit extracts, liquorice, vanillin, ethyl vanillin, coffee, tea, maple, menthol, mint, peppermint, spearmint, wintergreen, nutmeg, clove, lavender, cardamom, ginger, honey, anise, sage, cinnamon, sandalwood, jasmine, cascarilla, cocoa. The fruit extracts may be apple, cherry, strawberry, peach and citrus flavors, including lime and lemon. The non-tobacco flavorant may also comprise syrups, such as high fructose corn syrup. The non-tobacco flavorant is preferably one or more selected from the group of cocoa, menthol, fruit extracts and liquorice. Preferably, the non-tobacco flavorant constitutes less than 10% and preferably less than about 5% of the total weight of the tobacco-containing layer (40).

In a preferred embodiment, the tobacco-containing layer (40) comprises micronized tobacco powder, a binder and an aerosol-forming agent selected from the group consisting of polypropylene glycol, triethylene glycol, 1-3-butanediol, glycerin, glycerol monoacetate, glycerol diacetate, glycerol triacetate, triethyl citrate, ethyl myristate, isopropyl myristate, methyl stearate, dimethyl dodecanedioate and dimethyl tetradecanedioate.

In a particularly preferred embodiment, the tobacco-containing layer (40) comprises micronized tobacco powder, at least one binder selected from the group consisting of gellan gum, starch, and carboxymethyl cellulose and at least one of polypropylene glycol and glycerin.

Specifically, the tobacco-containing layer (40) may comprise micronized tobacco powder, carboxymethyl cellulose, polypropylene glycol and glycerin. The tobacco-containing layer may also comprise micronized tobacco powder, gellan gum, polypropylene glycol and glycerin. The tobacco-containing layer (40) may also comprise micronized tobacco powder, starch, polypropylene glycol and glycerin.

Method for Producing an Aerosol-Generating Article

In a second aspect, the present invention is directed to a method for producing an aerosol-generating article.

The method comprises the steps of:
preparing a tobacco-containing slurry,
depositing the tobacco-containing slurry onto a first sheet to form a sheet coated with a tobacco-containing layer,
attaching a paper sheet to the first sheet to form a wrapper before or after depositing the tobacco-containing slurry onto the first sheet so that the paper sheet and the tobacco-containing layer are on opposing sides of the first sheet, and
subsequently wrapping a rod of aerosol-generating substrate with the wrapper comprising the first sheet coated with the tobacco-containing slurry, so that the tobacco-containing layer is facing the rod of aerosol-generating substrate.

The aerosol-generating article according to the first aspect of the present invention is preferably produced by the method according to the second aspect of the present invention.

The tobacco-containing slurry may be prepared by dispersing tobacco particles in an aqueous dispersion medium. The tobacco particles are preferably tobacco powder having an average particle size of 30 μm or less. In a more preferred embodiment, the tobacco-containing slurry may be produced by adding tobacco powder to an aqueous medium and heating the dispersion comprising the tobacco powder to a temperature of 120° C. or higher. By heating the dispersion to 120° C. or higher, it is possible to decompose substances, such as hemicellulose, that cause thickening through interactions with water, thereby improving the viscosity of the slurry. The temperature is preferably 160° C. or higher. The temperature does preferably not exceed 200° C. A temperature exceeding 200° C. may cause degradation of active components. The temperature does more preferably not exceed 190° C. and does most preferably not exceed 180° C. Heating the dispersion to a temperature in the range of 160 to 180° C. allows to improve the viscosity of the slurry and at the same time preserve the active components delivering the taste upon heating in the aerosol-generating device. Heating may also be performed under pressure by using an apparatus, such as a pressure cooker.

The slurry is preferably relatively sticky. If the slurry is sticky, its adhesion to the heat-conductive sheet is improved.

The slurry may comprise tobacco powder, an aerosol-forming agent, and an aqueous dispersion medium. In addition, the slurry may also comprise a non-tobacco flavorant, a binder, and an agent for preserving tobacco. The components of the slurry may be mixed in a ribbon blender and may then be subjected to shear in a high-shear mixer. Then the slurry may be cast onto the heat-conductive sheet, for example on a moving endless belt. The cast slurry may be passed through a drying assembly to remove moisture such that a reconstituted tobacco-containing sheet is formed. In another embodiment of the present invention, air which has become entrained within the slurry may be removed from it prior to casting the slurry onto the heat-conductive sheet.

The aqueous dispersion medium herein refers to a liquid medium containing water. The aqueous dispersion medium may be water alone or may contain an organic compound. The organic compound is preferably water soluble and is more preferably selected from the group consisting of monohydric alcohols, diols, polyhydric alcohols, sugar alcohols, sugars, polyhydric alcohol esters, and combinations thereof. When the organic compound is insoluble in water, the organic compound can be dissolved in an aqueous dispersion medium by adding an amphiphilic organic compound, such as methanol.

Examples of the monohydric alcohols include methanol, ethanol, 1-propanol, 2-propanol, 1-butanol, 2-butanol, 2-methyl-1-propanol, 2,2-dimethylethanol, cyclohexanol, benzyl alcohol. The diol may be propylene glycol and the polyhydric alcohol may be glycerol.

Examples of the sugar alcohols include sorbitol, maltitol, xylitol, erythritol, lactitol, sorbitan, xylose, arabinose, mannose, and trehalose.

Examples of the sugars include lactose, table sugar, coupling sugar, glucose, enzyme-converted syrup, acid-converted syrup, maltose syrup, maltose, high-fructose corn syrup, fructose, hydrogenated maltose, hydrogenated starch syrup, and honey.

Examples of the polyhydric alcohol esters include fatty acid polyhydric alcohol esters, such as fatty acid triglycerides.

The aqueous dispersion medium can be used as a medium for wet grinding of tobacco. For the procedure of wet grinding, a mixed solvent of water and glycerol is preferably used. When the tobacco powder is obtained by dry fine grinding, a tobacco-containing slurry can be prepared by mixing finely ground tobacco particles with an aqueous medium.

The mixing ratio of water and the organic compound is not particularly limited and any suitable mixing ratio may be employed, particularly when a mixed solvent of water and glycerol is used. However, in view of handling properties and process safety, the water content in the aqueous dispersion medium is preferably 50% by weight or more, more preferably 80% by weight or more, and most preferably 90% by weight or more.

The tobacco powder, the aerosol-forming agent, the non-tobacco flavorant, and the binder each are preferably as defined in the first aspect of the present invention.

More particularly, the tobacco particles are preferably micronized tobacco powder and more preferably tobacco powder having a mean particle size of about 30 μm or less. The reduced particle size of the tobacco powder allows an increase in the solid content of the slurry without increasing the viscosity of the slurry.

The aerosol-forming agent may comprise one or more selected from the group consisting of polyhydric alcohols, diols, esters of polyhydric alcohols and aliphatic esters of mono-, di- or polycarboxylic acids. The aerosol-forming agent more preferably comprises one or more selected from the group consisting of polypropylene glycol (PG), triethylene glycol, 1-3-butanediol, glycerin, glycerol monoacetate, glycerol diacetate, glycerol triacetate, triethyl citrate, ethyl myristate, isopropyl myristate, methyl stearate, dimethyl dodecanedioate and dimethyl tetradecanedioate.

The binder may comprise gum, carbohydrate, or a combination thereof. The gum may be one or more compound(s) selected form the group consisting of gellan gum, xanthan gum, arabic gum, locust bean gum and agar agar. The carbohydrate may be a monosaccharide, a polysaccharide, a cellulose derivative or a combination thereof. The polysaccharide is preferably starch. The cellulose derivative is preferably one or more selected from the group consisting of hydroxypropyl-methylcellulose (HPMC), hydroxypropyl cellulose (HPC), carboxymethyl cellulose (CMC), hydroxyethyl cellulose, methyl cellulose (MC), and ethyl cellulose.

The first sheet is preferably a heat heat-conductive sheet. The heat-conductive sheet is more preferably a heat-conductive sheet as defined in the first aspect of the present invention. In particular, the heat-conductive sheet is more preferably made of a metal, even more preferably a metal selected from the group of aluminum, copper and tin, and most preferably aluminum. The heat-conductive sheet may have a thickness in the range of 0.005 mm to 0.2 mm, preferably 0.01 mm to 0.05 mm. The heat-conductive sheet may be part of a wrapper comprising an outer paper layer (32) and an inner layer (31) of the heat-conductive sheet. In this case, the tobacco-containing slurry is deposited on a side of the heat-conductive sheet opposed to the paper layer.

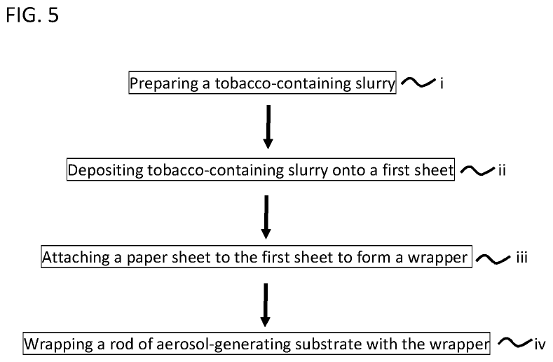

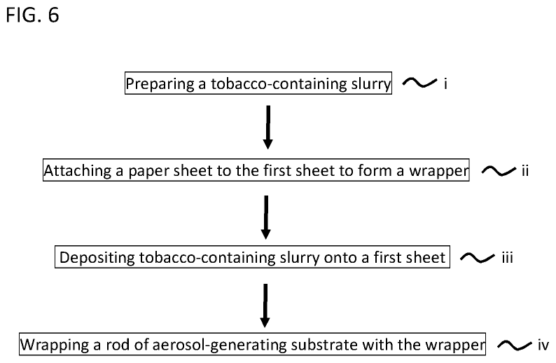

The method comprises a step of attaching a paper sheet to the first sheet to form a wrapper before or after depositing the tobacco-containing slurry onto the first sheet. FIGS. 5 and 6 show these two alternative sequences of the steps of the method of the present invention, i.e. procedures wherein the tobacco-containing slurry is either deposited before or after the paper sheet is attached. In case the paper sheet is attached after depositing the tobacco-containing slurry onto the first sheet, the paper sheet is attached to the side of the first sheet opposite to the tobacco-containing layer.

The method comprises a step of subsequently wrapping a rod of aerosol-generating substrate with the first sheet, so that the tobacco-containing layer is on the inner side of the first sheet facing the rod of aerosol-generating substrate. The rod of aerosol-generating substrate (tobacco rod) may be a rod of aerosol-generating substrate as defined in the first aspect of the present invention.

1. An aerosol-generating article for producing an inhalable upon heating in an aerosol-generating device, the aerosol-generating article comprising:
a rod of aerosol-generating substrate comprising tobacco,
a mouthpiece comprising a plug of filtration material,
a wrapper, and
a tobacco-containing layer comprising tobacco and an aerosol-forming agent,
wherein the rod of aerosol-generating substrate is wrapped by the wrapper and by the tobacco-containing layer, and
the tobacco-containing layer is positioned in contact with a surface of the wrapper.

2. The aerosol-generating article according to claim 1, wherein the tobacco-containing layer is coated or bound on an inner surface of the wrapper facing the rod of aerosol-generating substrate.

3. The aerosol-generating article according to claim 1, wherein the wrapper comprises a heat-conductive sheet and the tobacco-containing layer is in contact with the heat-conductive sheet.

4. The aerosol-generating article according to claim 3, wherein the heat-conductive sheet is made of aluminum.

5. The aerosol-generating article according to claim 3, wherein the wrapper comprises an outer paper layer and an inner layer facing the rod of aerosol-generating substrate, wherein the inner layer is the heat-conductive sheet.

6. The aerosol-generating article according to claim 1, wherein the aerosol-forming agent includes at least one of:
a polyhydric alcohol,
a diol,
an ester of a polyhydric alcohol, or
an aliphatic ester of a mono-, di- or polycarboxylic acid.

7. The aerosol-generating article according to claim 1, wherein the tobacco-containing layer comprises a binder.

8. The aerosol-generating article according to claim 7, wherein the binder includes at least one of:
gum,
monosaccharide,
disaccharide,
polysaccharide, or
cellulose derivative.

9. The aerosol-generating article according to claim 1, wherein the tobacco-containing layer has a thickness between 0.1 and 0.5 mm.

10. The aerosol-generating article according to claim 1, wherein the tobacco-containing layer comprises micronized tobacco powder.

11. The aerosol-generating article according to claim 10, wherein the tobacco powder has a particle size (Dv90) of 30 μm or less.

12. The aerosol-generating article according to claim 1, wherein the tobacco-containing layer further comprises non-tobacco flavorant.

13. The aerosol-generating article according to claim 1, wherein the tobacco in the aerosol-generating substrate is at least one of randomly oriented tobacco strands, randomly oriented tobacco shreds, or gathered tobacco sheets.

14. The aerosol-generating article according to claim 13, further comprising tobacco leaf, tobacco lamina, tobacco stem, tobacco scrap, reconstituted tobacco, cellulose pulp or combinations thereof.

15. The aerosol-generating article according to claim 1, wherein a tubular member is present between the rod of aerosol-generating substrate and the mouthpiece.

16. The aerosol-generating article according to claim 15, wherein the tubular member is hollow and is a paper or PLA tube.

17. The aerosol-generating article according to claim 15, wherein a tipping paper wraps over the mouthpiece, the tubular member and the rod of aerosol-generating substrate and at least partially overlaps with the wrapper).

18. The aerosol-generating article according to claim 1, further comprising an inductively heatable susceptor element in contact with the tobacco-containing layer.

19. A method for producing an aerosol-generating article, the method comprising the steps of:
preparing a tobacco-containing slurry,
depositing the tobacco-containing slurry onto a first sheet to form a sheet coated with a tobacco-containing layer,
attaching a paper sheet to the first sheet to form a wrapper before or after depositing the tobacco-containing slurry onto the first sheet so that the paper sheet and the tobacco-containing layer are on opposing sides of the first sheet, and
subsequently wrapping a rod of aerosol-generating substrate with the wrapper comprising the first sheet coated with the tobacco-containing slurry, so that the tobacco-containing layer is facing the rod of aerosol-generating substrate.

20. The method according to claim 19, wherein the first sheet is a heat-conductive sheet.
